(19) United States
(12) Patent Application Publication
(10) Pub. No.: US 2026/0226692 A1
(43) Pub. Date: Aug. 6, 2026

(54) SYSTEMS AND METHODS FOR ROAD MILLING WITH ADAPTIVE PLUNGE VELOCITY

(71) Applicant: Caterpillar Paving Products Inc., Brooklyn Park, MN (US)

(72) Inventors: Nicholas J. Argenziano, Otsego, MN (US); Eric S. Engelmann, Delano, MN (US); Ryan Hutar, Plymouth, MN (US); Garrett Daniel Reed, Big Lake, MN (US)

(73) Assignee: Caterpillar Paving Products Inc., Brooklyn Park, MN (US)

(21) Appl. No.: 19/046,284

(22) Filed: Feb. 5, 2025

(51) Int. Cl. E01C 23/088; E01C 23/12

(52) U.S. Cl. CPC E01C 23/088; E01C 23/127; E01C 2301/00

(57) ABSTRACT

A work machine includes a frame, a milling drum, a traction device, a pressure sensor, and a controller. The milling drum is connected to the frame. The traction device includes an actuator configured to controllably raise and lower the frame relative to a work surface. The pressure sensor is operatively connected to and configured to measure a pressure of the actuator. The controller is communicatively connected to the pressure sensor and configured to receive information from the pressure sensor indicative of the pressure of the actuator and control a rate at which the milling drum descends into the work surface based on the pressure.

### TECHNICAL FIELD

This disclosure relates generally to systems and methods for road milling with adaptive plunge velocity.

### BACKGROUND

Work machines that mill or otherwise process a road or other terrain commonly include a milling head that can be lowered into engagement with the surfaced being processed. Such work machines include road milling and mixing machines, rotary mixers, and cold planers, which may be referred to generally in this disclosure as milling work machines or milling machines.

Milling work machines may lower a rotating cutting head or drum into the surface of a road to cut and otherwise process the road. The milling machine can lower the cutting head at various, controllable speeds, which is sometimes referred to as the plunge velocity. The plunge velocity can affect the quality of the road milling operation and other aspects of operation of the milling work machine.

In some cases, due to various factors including depth of cut and material characteristics of the road like density and/or hardness, plunging the cutting head into the road at too high speed can result in an equal and opposite upward force of sufficient magnitude to undesirably lighten or lift one or more of the traction devices of the milling machine.

U.S. Pat. No. 10,386,866, entitled “AUTOMATIC CONTROL OF PLUNGE VELOCITY BASED ON DEPTH OF CUT” discloses systems and methods related to automatically controlling plunge velocity of milling work machines based on depth of cut.

### SUMMARY

An example work machine includes a frame, a milling drum, a traction device, a pressure sensor, and a controller. The milling drum is connected to the frame. The traction device includes an actuator configured to controllably raise and lower the frame relative to a work surface. The pressure sensor is operatively connected to and configured to measure a pressure of the actuator. The controller is communicatively connected to the pressure sensor and configured to receive information from the pressure sensor indicative of the pressure of the actuator and control a rate at which the milling drum descends into the work surface based on the pressure.

An example method includes: receiving information from one or more pressure sensors indicative of a pressure of an actuator of a work machine, the work machine including a milling drum connected to a frame and a traction device including the actuator, the actuator configured to controllably raise and lower the frame relative to a work surface; and controlling a rate at which the milling drum descends into the work surface based on the pressure.

These and other examples and features of the present devices, systems, and methods will be set forth in part in the following Detailed Description. This overview is intended to provide a summary of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 schematically depicts a system including an example milling work machine according to this disclosure.

FIG. 2 is a block diagram schematically depicting portions of the systems and milling work machine of FIG. 1.

FIGS. 3A and 3B schematically depicts an example four-post rotary mixer work machine according to this disclosure.

FIG. 4 schematically depicts an example fixed chassis/frame rotary mixer work machine according to this disclosure.

FIG. 5 is flow chart depicting an example method in accordance with this disclosure.

### DETAILED DESCRIPTION

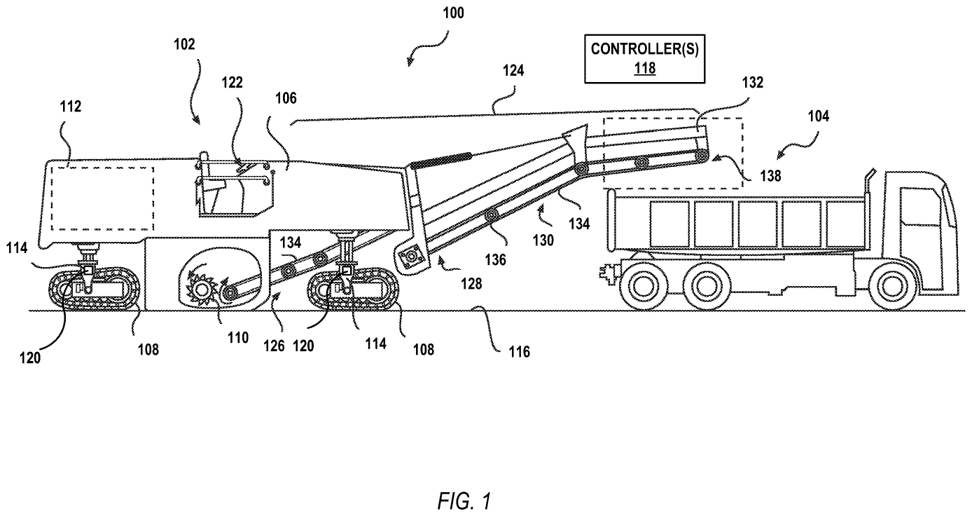

FIG. 1 depicts example system 100 in accordance with this disclosure. System 100 includes milling work machine 102 at a worksite used to perform a roadway milling operation in conjunction with haul vehicle(s) 104. Work machine 102 can include a variety of types of milling work machines including, as examples, cold planers and rotary mixers. Independent of type, work machine 100 may be an operator-controlled, autonomous, or semi-autonomous machine.

Milling machine 102, which in the example of FIG. 1 can be a cold planer work machine including frame 106 supported by one or more traction devices 108, milling drum 110 rotationally supported under a belly of frame 106, and an engine 112 mounted to frame 106 and configured to drive milling drum 110 and traction devices 108. Traction devices 108 may include either wheels or tracks connected to actuators 114 that are adapted to controllably raise and lower frame 106 relative to work surface 116. In examples according to this disclosure, raising and lowering of frame 106 may also function to vary a milling depth of milling drum 110 into surface 116. In examples, milling machine 102 can include other mechanisms, which are associated with frame 106 and/or milling drum 110, and which are configured to control milling depth of milling drum 110 and other parameters of the milling operation, including, e.g. plunge velocity/speed.

For example, the position of frame 106 relative to a ground surface may remain constant and milling drum 110 may be operatively connected to actuators that are configured to raise and lower the milling drum relative to work surface 116 and control, e.g., milling depth and other parameters of the milling operation. In an example, milling machine 100 can include traction devices 108 with actuators 114 to controllably raise and lower frame 106 relative to surface 116 and actuators operatively connected to milling drum 110 to raise and lower milling drum 110 relative to surface 116 and/or frame 106, one or more of which actuators independently or in conjunction with one another can control parameters of milling operations carried out by milling machine 100, including, e.g. the plunge velocity of milling drum 110.

In the example depicted in FIG. 1, milling work machine 100 can be a cold planer. In such an example, traction devices 108 can include either wheels or tracks connected to actuators 114, which are connected to frame 106. Milling drum 110 can be fixedly connected to frame 106. In examples in which milling work machine 100 is a cold planer, actuators 114 are adapted to controllably raise and lower frame 106 relative to work surface 116, which, in turn, also functions to raise and lower milling drum 110 relative to surface 116.

Example system 100 also includes a controller or multiple controllers 118, which can be located somewhere on or remote from milling work machine 102 and communicatively connected to one or more components of the machine, including, e.g. milling drum 110 and actuators 114. Additionally, controller(s) 118 can include a plurality of controllers located at/distributed to different locations and communicatively connected to each other and to milling work machine 102. In examples, controller(s) 118, whether on board or remote from machine 102, can be connected to various components of and autonomously, semi-autonomously, or via operator input control aspects of operation of the machine.

For example, controller(s) 118 can be communicatively connected to milling drum 110 and actuators 114 and configured to control a rate at which milling drum 110 descends into work surface 116 based on sensor input. Milling work machine 102 can include, for example, one or more pressure sensor(s) 120 associated with, connected to, and/or configured to measure pressure of actuators 114. In an example, each of the four (two forward/leading and two rearward/trailing) actuators 114 of milling work machine 120 can include a pressure sensor 120, which is configured to measure pressure of the respective actuator. Regardless of the number and particular arrangement, pressure sensor(s) 120 can be communicatively connected to controller(s) 118 and configured to send information (e.g., one or more analog or digital signals) to the controller(s) indicative of the pressure of the actuators 114, based upon which the controller(s) can modulate the plunge velocity of milling drum 110.

The plunge velocity of the milling drum of a milling work machine or the rate at which the milling drum descends into a work surface can affect a number of aspects of the performance of the machine. For example, if the plunge velocity exceeds a certain threshold, the reactive force by the surface on the machine as the milling drum descends there into can exceed the weight of the machine. In other words, too rapid a plunge velocity can lighten or lift one or more of the traction devices of the machine off the ground or otherwise disadvantageously de-weight the machine.

Although the plunge velocity of a milling drum can be measured and controlled in a variety of ways, an elegant way to control plunge velocity to prevent de-weighting can be to track the pressure of the actuators that raise and lower the milling drum relative to the surface. The pressure of the actuators can act as a somewhat direct measurement of de-weighting and allow for closed loop control of milling drum plunge velocity without disadvantageous effects, e.g. de-weighting of the machine.

In an example according to this disclosure, pressure sensor(s) 120 can be configured to measure the pressure of one or more of actuators 114 of milling work machine 102 and to send information to controller(s) 118 indicative of the measured pressure. Controller(s) 118 can be configured to receive the information indicative of the pressure of actuators 114 and control a rate at which milling drum 110 descends into work surface 116 based on the pressure.

Frame 106 of milling work machine 102 can also support operator station 122. Operator station 122 may house any number of input/output (I/O) device(s) and may include or be communicatively connected to controller(s) 118. In examples, operator station 122 may be offboard of milling work machine 102. For example, operator station 122 may embody a remote control, such as a handheld controller, that an operator may use to control various aspects of operation of milling machine 102 from various locations. Operator station 122 can be implemented in a software program and associated user interface and may include a combination of hardware and software. In other embodiments, milling work machine 102 may be autonomous and may not include operator station 122.

Example system 100 can also include conveyor system 124, which can be pivotally connected at a leading end to frame 106 and configured to transport material away from milling drum 110 and into a receptacle, such as haul vehicle 104. Conveyor system 124 can include first conveyor 126 adjacent milling drum 110 that is configured to transfer milled material to a trailing end 128 of second conveyor 130. Conveyors 126 and 130 can each include frame 132, and conveyor belt 134 that is supported on a plurality of roller assemblies 136, including a belt head roller assembly at leading end 138 of second conveyor 130, and driven by a motor, which may be powered by engine 112 or by another power source.

As part of a milling operation, milling work machine 102 can mill surface 116 of the roadway and transfer milled material into a first of a plurality of haul vehicles (“haul vehicle”) 104. In some situations, a second haul vehicle may be in a standby position near work machine 102, and a third haul vehicle may be located at or near a plant, such as at an associated dispatch facility. Any number of haul vehicles may be positioned near milling machine 102 (e.g., in the standby position) and/or at an associated plant (e.g., awaiting dispatch). When full, haul vehicle 104 may depart from work machine 102 to deliver the milled material to a plant, and another haul vehicle may approach work machine 102 to replace haul vehicle 104 so the milling operation may continue.

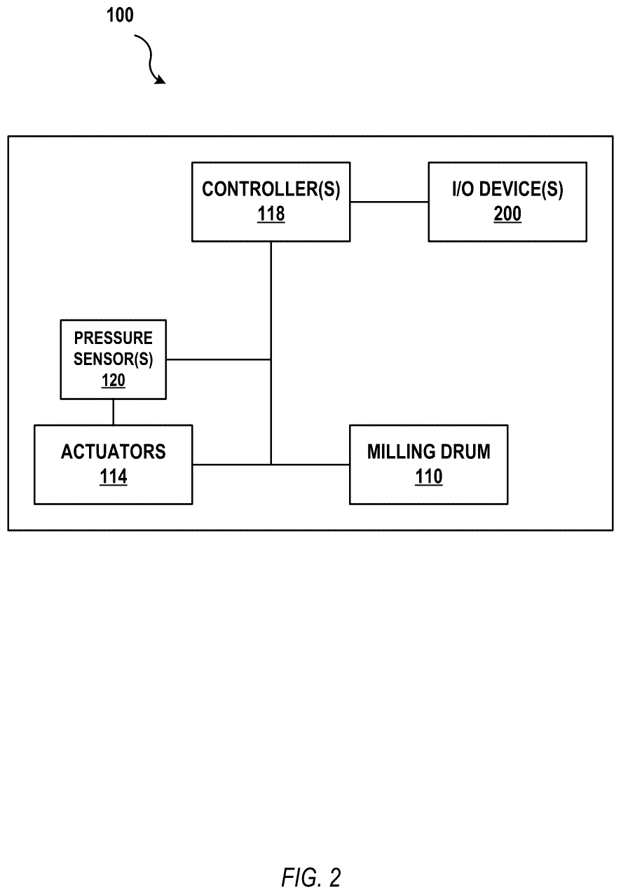

FIG. 2 schematically depicts portions of example system 100, including milling drum 110, actuators 114, controller(s) 118, and pressure sensor(s) 120. Additionally, example system 100 includes one or more I/O device(s) 200 associated with operator control, including, e.g., operator station 122. Controller(s) 118 is communicatively connected to pressure sensor(s) 120 and I/O device(s) 200. Additionally, controller(s) 118 is operatively connected to and configured to control aspects of the operation of actuators 114 and milling drum 108 directly or indirectly via one or more additional components of system 100. As an example, actuators 114 can each include hydraulic cylinders configured to raise and lower frame 106 of milling work machine 102 relative to work surface 116. Such hydraulic cylinders can be part of a hydraulic system of work machine 102 that includes a fluid reservoir and pump configured to pressurize hydraulic fluid and to direct the pressurized fluid to the cylinders (and other hydraulically driven components of the hydraulic system). In an example, controller(s) 118 can be operatively connected to and configured to control actuators 114 via control of the pump of the hydraulic system.

Pressure sensor(s) 120 are operatively associated with actuators 114, e.g. connected to and/or arranged and configured to measure a pressure of the actuators. Pressure sensors 120 can include a variety of types of sensors, including absolute and/or differential pressure sensors. Additionally, pressure sensors 120 can employ different mechanisms to measure pressure in actuators 114. In examples, pressure sensors can include sealed, resistive, piezoelectric, capacitive, and/or optical pressure sensors.

I/O device(s) 200 can include a variety of types of devices for displaying or otherwise outputting information and for inputting information and/or control commands. For example, I/O device(s) 200 can be configured to render the location of milling machine 102 and milling drum 110 relative to features of a jobsite (e.g., milled and/or unmilled parts of surface 116), and to display data and/or other information to the operator, such as the types of pavement material to be milled by milling drum 110, available depths of cut for the particular milling machine and milling drum, and available plunge velocities or speeds at which the milling drum may or is being lowered into a pavement surface of a particular material and for a particular depth of cut. Additionally, I/O device(s) can be configured to receive data and/or control instructions from the operator of milling work machine 102.

In examples, I/O device(s) 200 can include, among other things, a display and one or more other analog and/or digital input devices, including keyboard, mouse, touchpad, and/or touchscreen. In an example, I/O device(s) 200 can include an analog input device that receives control instructions via one or more buttons, switches, dials, levers, etc. I/O device(s) 200 can also or alternatively include digital components, such as one or more soft keys, touch screen icons, and/or visual displays, including various icons that can be activated by touch on various displays/touch screens.

I/O device(s) 200 can be configured to generate one or more signals indicative of various parameters associated with milling work machine 102 and/or its surrounding environment based on input received from the operator and/or data received from off-board the machine, such as from a control center or other databases, which may be accessed via the cloud over wireless networks. For example, I/O device(s) 200 can be configured to receive inputs indicative of milled material density, a material type, and parameters of haul vehicle 104 and work machine 102 (e.g., dimensions, volume capacity, weight capacity, legal weight limit, type of cutting tools installed on milling drum 110, range of rotational speeds at which milling drum 110 can be driven, desired cutting depths, available and/or threshold plunge velocities for milling drum 110, in some cases corresponding to different depths of cut and materials being milled, etc.).

As generally described with reference to FIG. 1, pressure sensor(s) 120 can be configured to measure the pressure of one or more of actuators 114 of milling work machine 102 and to send information to controller(s) 118 indicative of the measured pressure. The pressure measurements taken by pressure sensor(s) 120 and based upon which controller(s) 118 control the plunge velocity of milling drum 110 can be from one or more of actuators 114. In an example, controller(s) 118 control the plunge velocity of milling drum based on the pressure of the two forward actuators 114, as these may more directly affect the quality of the cut made by milling drum 110 of milling work machine 100. Regardless of the number or particular combination of actuators 114 pressure that is employed, controller(s) 118 can be configured to receive the information indicative of the pressure of actuators 114 and control a rate at which milling drum 110 descends into work surface 116 based on the pressure.

For example, controller(s) 118 can receive the information indicative of the pressure of actuators 114 from pressure sensor(s) 120 and compare the pressure of actuators 114 to a threshold pressure. Controller(s) 118 can then control the rate at which milling drum 110 descends into work surface 116 based on the comparison. In an example, a threshold pressure can be determined and set at a pressure value at which milling work machine 102 will or may become undesirably de-weighted. Such threshold pressure can be stored in memory of and read by controller(s) 118, as an example. On condition controller(s) 118 determine that the pressure of one or more of actuators 114 measured by pressure sensor(s) 120 crosses the threshold pressure, the controller can be configured to change the rate at which milling drum 110 descends into work surface 116.

For example, controller(s) 118 can be configured to reduce the plunge velocity of milling drum 110 in the event the comparison of measured pressure to threshold pressure is indicative that one or more of actuators 114 are or may become disadvantageously de-weighted. Conversely, controller(s) 118 can be configured to maintain or increase the plunge velocity of milling drum 110 in the event the comparison of measured pressure to threshold pressure is indicative that one or more of actuators 114 are not or likely will not be de-weighted.

The pressure of actuators 114 information based upon which controller(s) 118 controls the plunge velocity of milling drum 110 can be an absolute pressure or other pressure measurement. For example, controller(s) 118 can control the rate at which milling drum 110 descends into work surface 116 based on a change in pressure and/or a rate of change in pressure of actuators 114.

In an example, controller(s) 118 can receive the information from pressure sensor(s) 120 indicative of a plurality of pressures of actuators 114, e.g. at a plurality of different times. Controller(s) 118 can determine a change in pressure of the actuator based on the plurality of pressures of actuators 114. Controller(s) 118 can then control the rate at which milling drum 110 descends into work surface 116 based on the change in pressure. For example, controller(s) 118 can compare the change in pressure of actuators 114 to a threshold change in pressure and control the rate at which milling drum 110 descends into work surface 116 based on the comparison.

In an example, controller(s) 118 can receive the information from pressure sensor(s) 120 indicative of a plurality of pressures of actuators 114, e.g. at a plurality of different times. Controller(s) 118 can determine a rate of change in pressure of the actuator based on the plurality of pressures of actuators 114. Controller(s) 118 can then control the rate at which milling drum 110 descends into work surface 116 based on the rate of change in pressure of actuators 114. For example, controller(s) 118 can compare the rate of change in pressure of actuators 114 to a threshold rate of change in pressure and control the rate at which milling drum 110 descends into work surface 116 based on the comparison.

The threshold pressure, including absolute pressure value(s) and change in pressure or rate of change in pressure can be implemented in a variety of different ways. For example, threshold pressures may vary by particular milling machine and/or job site/operating context and may be preprogrammed into memory of controller(s) 118 or another component of system 100. Additionally, multiple threshold pressures may be made available for a particular machine and can be selected, e.g. by an operator via I/O device(s) 200 of operator station 122.

The comparison of the threshold pressure to pressure of one or more of actuators 114 measured by pressure sensor(s) 120 can vary depending upon the manner in which the pressure is measured. In an example, actuators 114 can be hydraulic cylinders and pressure sensor(s) 120 can be arranged and configured to measure pressure on the head and rod end of one or more of actuators 114. For example, a first pressure sensor can be configured to measure a pressure on the head end of one of actuators 114 and a second pressure sensor 120 can be configured to measure a pressure on a rod end of the actuator. In examples, controller(s) 118 calculate a measured differential pressure that is equal to the head pressure minus the rod pressure measured by pressure sensor(s) 120. In such an example, on condition controller(s) 118 determine that the differential pressure of one or more of actuators 114 measured by pressure sensor(s) 120 is less a threshold differential pressure, the controller can be configured to reduce the rate at which milling drum 110 descends into work surface 116.

However, in another example, pressure sensor(s) 120 can be arranged and configured to measure pressure on the head and rod end of one or more of actuators 114 and controller(s) 118 calculate a measured differential pressure that is equal to the rod pressure minus the head pressure measured by pressure sensor(s) 120. In such an example, on condition controller(s) 118 determine that the differential pressure of one or more of actuators 114 measured by pressure sensor(s) 120 is greater a threshold differential pressure, the controller can be configured to reduce the rate at which milling drum 110 descends into work surface 116.

In examples, the rate at which milling drum 10 descends into work surface 116 can be controlled by controller(s) 118 based on pressure in different ways. In an example, controller(s) 118 can be configured to initially control milling drum 110 to descend into the work surface at a default rate, which may be a relatively low rate. Controller(s) 118 then receive information from pressure sensor(s) 120 indicative of the pressure of actuator(s) 114 and change the rate at which milling drum 110 descends into work surface 116 based on the pressure, e.g. by comparing the measured pressure to a threshold.

In another example, controller(s) 118 can be configured to find a max plunge velocity of milling drum 110. For example, controller(s) 118 can be configured to vary the rate at which milling drum 110 descends into work surface 116. In an example, controller(s) 118 incrementally increase the rate at which milling drum 110 descends into work surface 116 while also receiving information from pressure sensor(s) 120 indicative of the pressure of actuators 114 and comparing the pressure to a threshold. When the measured pressure reaches the threshold pressure, controller(s) 118 can set a constant rate at which milling drum 110 descends into work surface 116.

As noted above, the manner in which a milling drum is plunged/descends into a work surface on a milling work machine can vary depending upon the machine. For example, on a cold planer the machine frame/chassis may be coupled to movable actuators and the milling drum may be fixedly coupled to the frame. The actuators of the cold planer are configured to raise and lower the machine, and thereby the milling drum.

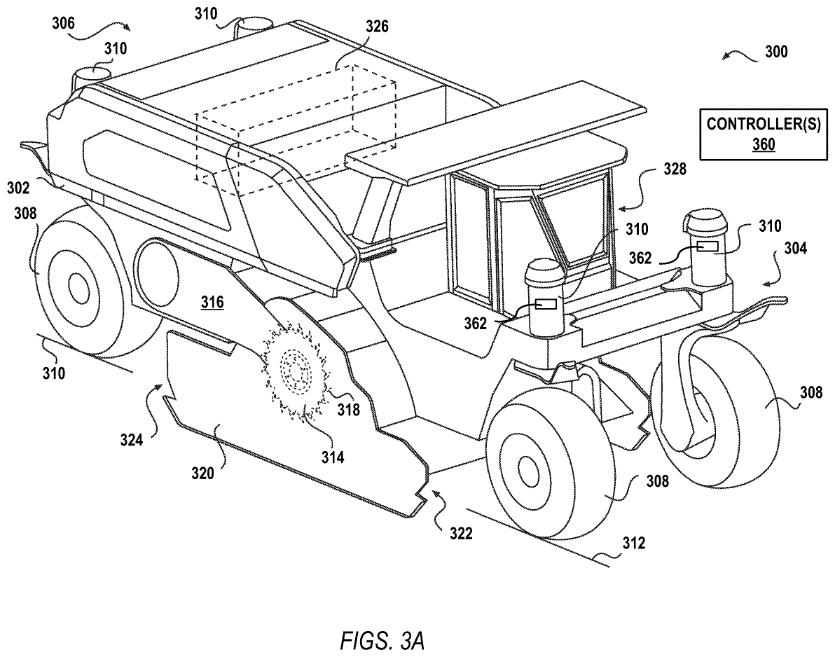

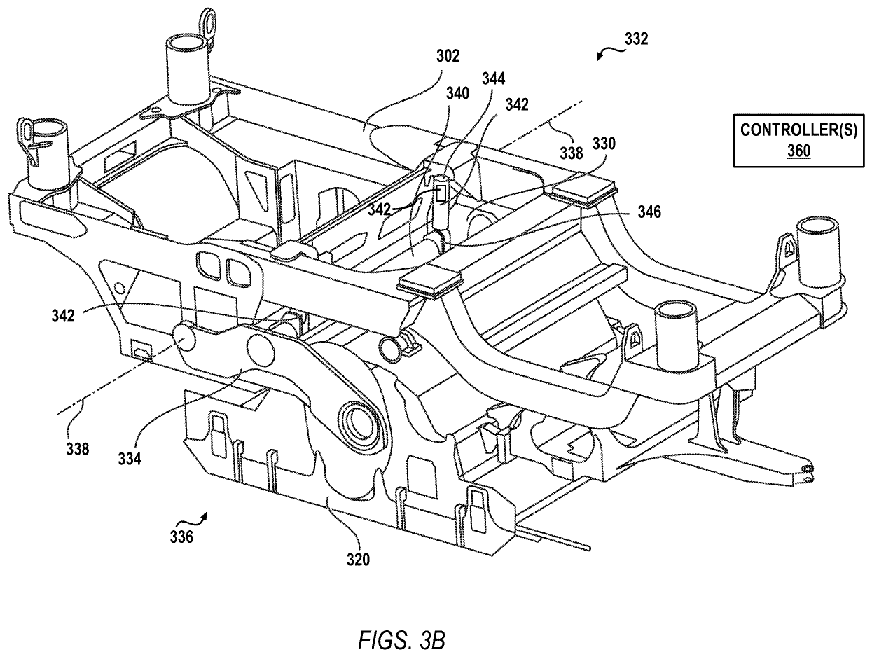

On a four-post rotary mixer, an example 300 of which is depicted in FIGS. 3A and 3B, the machine frame movable relative to the work surface and the milling drum can be movable relative to the frame and the work surface. Referring to FIG. 3A, four-post rotary mixer 300 can include frame 302, which may extend from first end 304 to second end 306 of the rotary mixer. Frame 302 is supported on traction devices 308 (one of which is not visible in FIG. 3A), which can take the form of wheels as in the depicted example, or tracks in other examples. Frame 302 is connected to traction devices 308 by leg actuators 310. One or more of leg actuators 310 may be height adjustable such that a height of frame 302 relative to one or more of traction devices 308 and work surface 312 may be increased or decreased by adjusting a length of one or more of actuators 310.

Rotary mixer 300 includes milling drum 314 attached to frame 302 via arms 316. Arms 316 includes a pair of arms (only one of which is visible in FIG. 3A) disposed on either side of four-post rotary mixer 300 and milling drum 314 includes cutting tools/teeth 318. Milling drum 314 can be enclosed within drum chamber 320 which may help contain the material removed by teeth 318 from work surface 310. Rotation of milling drum 314 may cause the removed material to be transferred from adjacent front end 322 towards rear end 324 of drum chamber 320.

Four-post rotary mixer 300 includes engine 326 and operator platform 328. Engine 326 can be any suitable type of internal combustion engine, such as a gasoline, diesel, natural gas, or hybrid-powers engine. Additionally, engine 326 can be driven by electrical power. Engine 326 can be configured to deliver rotational power output to hydraulic motor(s) associated with, e.g., traction devices 308, actuators 310, and milling drum 314, and to deliver power to other components or accessory devices of rotary mixer 300.

FIG. 3B illustrates a portions and components of four-post rotary mixer 300 not visible in FIG. 3A. Referring to FIG. 3B, arms 316 include left arm 330 disposed on left side 332 of rotary mixer 300 and right arm 334 disposed on right side 336. Left and right arms 330, 334 can be pivotably attached to and configured to rotate relative to frame 302. Left and right arms 330, 334 can have a common pivot axis 338 disposed transverse to and generally parallel to a width direction of frame 302. Cross tube or shaft 340 can be fixedly connected at one to left arm 330 and at an opposite end to right arm 334. Arm actuators 342 can be connected between frame 302 and cross tube 340. For example, one end 344 of arm actuator 342 is connected to frame 302 and an opposite end 346 of arm actuator 342 is connected to cross tube 340. Arm actuators 342 can include a variety of actuators, including, e.g., single-acting or double-acting hydraulic or pneumatic actuators, a rack and pinion arrangement, a belt and pulley arrangement, etc.

In examples according to this disclosure, a height of milling drum 314 of four-post rotary mixer 300 relative to work surface 310 can be adjusted by rotating arms 316 and/or by adjusting one or more of leg actuators 310. Raising and lowering milling drum 314 via leg actuators 310 and/or arm actuators 342 can function to vary a milling depth and other parameters of the milling operation, including, e.g. plunge velocity/speed. The plunge velocity of milling drum 314 can be controlled, e.g., to prevent de-weighting by tracking the pressure of the actuators that raise and lower the milling drum relative to the surface, e.g. by tracking the pressure of leg actuators 310 and/or arm actuators 342.

In examples, controller or multiple controllers 360 can be located somewhere on or remote from rotary mixer 300 and communicatively connected to one or more components of the machine, including, e.g. milling drum 314, leg actuators 310, and/or arm actuators 342. Controller(s) 360 can include a plurality of controllers located at/distributed to different locations and communicatively connected to each other and to rotary mixer 300. In examples, controller(s) 360, whether on board or remote from rotary mixer 300, can be connected to various components of and autonomously, semi-autonomously, or via operator input control aspects of operation of the machine.

Controller(s) 360 can be communicatively connected to milling drum 314, leg actuators 310, and/or arm actuators 342 and configured to control a rate at which milling drum 314 descends into work surface 312 based on sensor input. Rotary mixer 300 can include, for example, one or more leg pressure sensor(s) 362 associated with, connected to, and/or configured to measure pressure of leg actuators 310, and/or one or more arm pressure sensor(s) 364 associated with, connected to, and/or configured to measure pressure of arm actuators 342. Regardless of the number and particular arrangement, leg pressure sensor(s) 462 and/or arm pressure sensor(s) 464 can be communicatively connected to controller(s) 360 and configured to send information (e.g., one or more analog or digital signals) to the controller(s) indicative of the pressure of leg actuators 310 and/or arm actuators 342, based upon which the controller(s) can modulate the plunge velocity of milling drum 314.

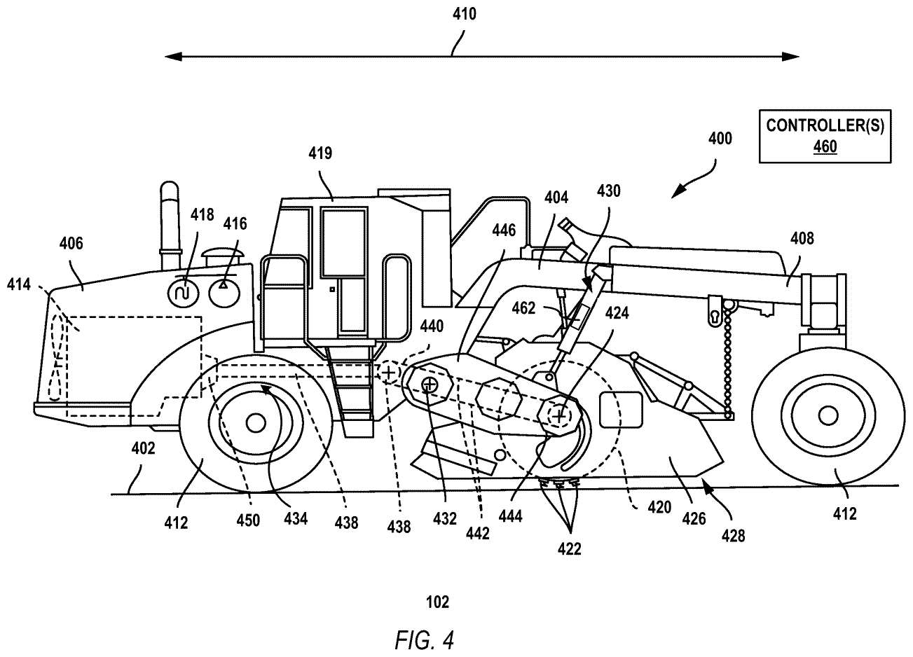

On a fixed chassis rotary mixer, an example 400 of which is depicted in FIG. 4, the machine frame can be fixed relative to the work surface and the milling drum can be configured to raise and lower relative to the work surface. In FIG. 4, rotary mixer 400 is configured to remove and reclaim or reuse a layer of a work surface 402 such as pavement, concrete, asphalt, or other material by penetrating into and fracturing the work surface in a milling operation. The fractured material may be redeposited on the work surface 402 where it can be used as a foundation or base aggregate in a subsequent paving operation.

Rotary mixer 400 can include frame 404 oriented with forward end 406 and rearward end 408 that are aligned along travel direction 410 of the machine; however, because the rotary mixer 100 may operate in both forward and reverse directions, the designations are used herein primarily for reference purposes. Frame 104 can be supported on a plurality of traction devices 412. In the illustrated embodiment, traction devices 412 are rotatable wheels that can include rubber pneumatic tires. In other examples, fixed chassis rotary mixer 400 includes continuous tracks such as a closed belt disposed about rollers and/or sprockets where translation of the belt carries the rotary mixer over work surface 402.

To power traction devices 412 and other systems of the rotary mixer 100, a power source, e.g., internal combustion engine 414 can be disposed on frame 404. Rotary output of engine 414 can be transmitted through a crankshaft extending from the engine and operatively associated with traction devices 412 and other systems. For example, engine 414 can be operatively coupled to and drive other power systems on rotary mixer 400 such as a machine hydraulic system including one or more hydraulic pumps 416 for pressurizing and directing hydraulic fluid through hydraulic conduits like hoses or tubing. In examples, traction devices 412 may be hydrostatically driven and are operatively associated with hydraulic motors that can be fluidly coupled to hydraulic pump 416 to receive pressurized hydraulic fluid there from causing rotation of the wheels. Another exemplary system that may be included with rotary mixer 100 and powered by internal combustion engine 414 can be an electric alternator or electric generator 418 to generate electricity for an electrical system.

To accommodate an operator, rotary mixer 400 can include onboard operator cab or operator station 419 on frame 404 at a location that provides visibility over and about the work surface 402 for conducting the milling operation. Operator station 419 can include various controls, readouts, and other input/output interfaces and instrumentation for monitoring and controlling operation of rotary mixer 400, including, for example, steering joysticks or steering handles for adjusting the travel direction of the rotary mixer, speed controls for adjusting the travel speed of the rotary mixer, and controls for adjusting the other systems associated with the rotary mixer like hydraulic pump 416 and electric generator 418. In other examples, rotary mixer 400 may be configured for remote operation and some or all of the foregoing operator controls may be located remotely from onboard operator station 419.

To engage and fragment the work surface 402, fixed-chassis rotary mixer 400 can include milling drum 420 rotatably mounted on and supported by frame 404. Milling drum 420 can be a drum-shaped, cylindrical structure having a plurality of picks or teeth-like cutting tools 422 disposed about its cylindrical surface. Milling drum 420 can rotate about rotor axis 424 that is generally perpendicular to the travel direction 410 and that extends between the first and second lateral sides of machine frame 404.

To contain the fragmented material and debris, milling drum 420 can be rotatably accommodated in a box-like housing or rotor enclosure 426 that extends from frame 404 toward work surface 402. Rotor enclosure 426 can be made from a plurality of metal plates and defines enclosed space 428 in which milling drum 420 is located.

To vertically raise and lower milling drum 420 with respect to the work surface 402, piston 430 can be located on each lateral side of rotary mixer 400 and can be connected between machine frame 404 and drive belt/chain housing 446. In examples, pistons 430 can be operatively associated with the hydraulic system on rotary mixer 400 and can be fluidly coupled to hydraulic pump 416 via hydraulic lines. Directing pressurized hydraulic fluid to and from pistons 430 causes the pistons to telescopically expand or contract, thereby increasing or decreasing the length of the pistons extending between machine frame 404 and belt/chain housing 446. Milling drum 420 thus pivots or tilts about pivotal connection 432 and is brought into contact and can penetrate into work surface 402 during the milling operation and the depth of the milling cut can be controlled through selective adjustment of the extension of the hydraulic pistons 430.

To cause rotation, cutting rotor 420 of rotary mixer 400 is operatively coupled to internal combustion engine 414 via an assembly of components referred to as drivetrain 434. Drivetrain 434 can include driveshaft 436 joined to the crankshaft of internal combustion engine 414 through a flywheel—clutch combination at the rear of the engine. Driveshaft 436 can be coupled by differential 438 or similar gear train to axle 440. The axial ends of axle 440 can be formed as sprockets or pulleys adapted to mesh with one or more rotor drive belts or chains 442 that extend to and pass about rotor hub 444. Drive belts/chains 442 transmit mechanical power from the rotation of axle 440 to rotor hub 444 causing rotation of cutting rotor 420. In examples, rotary mixer 400 can be configured to operate cutting rotor 420 at different rotational speeds and/or torques via rotor drive transmission 450.

In examples according to this disclosure, raising and lowering milling drum 420 via piston 430 can function to vary a milling depth and other parameters of the milling operation, including, e.g. plunge velocity/speed. The plunge velocity of milling drum 420 can be controlled, e.g., to prevent de-weighting by tracking the pressure of the actuators that raise and lower the milling drum relative to the surface, e.g. by tracking the pressure of piston 430.

In examples, controller or multiple controllers 460 can be located somewhere on or remote from rotary mixer 400 and communicatively connected to one or more components of the machine, including, e.g. milling drum 420 and/or piston 430. Controller(s) 460 can include a plurality of controllers located at/distributed to different locations and communicatively connected to each other and to rotary mixer 400. In examples, controller(s) 460, whether on board or remote from rotary mixer 400, can be connected to various components of and autonomously, semi-autonomously, or via operator input control aspects of operation of the machine.

Controller(s) 460 can be communicatively connected to milling drum 420 and piston 430 and configured to control a rate at which milling drum 420 descends into work surface 402 based on sensor input. Rotary mixer 400 can include, for example, one or more pressure sensor(s) 462 associated with, connected to, and/or configured to measure pressure of piston 430. Regardless of the number and particular arrangement, pressure sensor(s) 462 can be communicatively connected to controller(s) 460 and configured to send information (e.g., one or more analog or digital signals) to the controller(s) indicative of the pressure of piston 430, based upon which the controller(s) can modulate the plunge velocity of milling drum 420.

### INDUSTRIAL APPLICABILITY

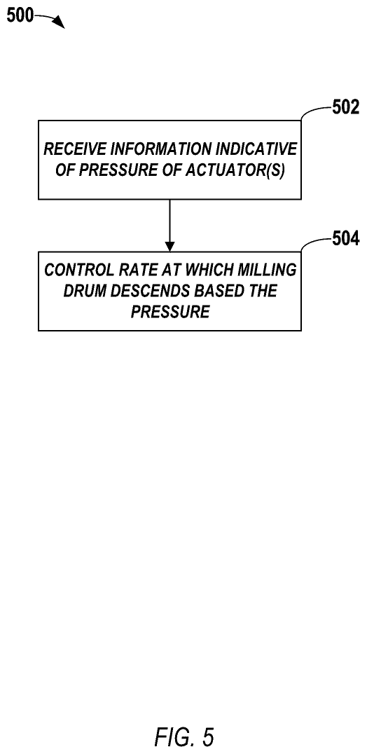

FIG. 5 is a flowchart depicting example method 500 in accordance with examples of this disclosure. Example method 500 includes receiving information from a pressure sensor indicative of a pressure of an actuator of a work machine (502) and controlling a rate at which the milling drum descends into the work surface based on the pressure (504). The work machine can be a milling work machine including a milling drum connected to a frame and a traction device including the actuator. The actuator can be configured to controllably raise and lower the frame relative to a work surface.

In an example, an operator of work machine 102 controls aspects of operation of the machine via operator station 122. The operator prepares to commence cutting work surface 116 with milling drum 110. Using I/O device(s) 200, the operator configures various parameters of the milling operation, including, e.g. depth of cut and plunge velocity. In an example, the operator selects a depth of cut for the milling operation. Controller(s) 118 then present the operator, e.g., via a display device of I/O device(s) 200 with a number of different options for plunge velocity of milling drum 110 at the selected depth of cut. For example, controller(s) 118 can request that the operator input a threshold pressure (including absolute pressure value, change in pressure, or rate of change in pressure) of one or more of actuators 114 above which controller(s) 118 will automatically reduce the plunge velocity of milling drum 110. In an example, controller(s) 118 presents a number of different possible threshold pressure values for selection by the operator. In an example, controller(s) 118 displays one or more of the foregoing options and also an option to find a maximum plunge velocity of milling drum 110, under which option controller(s) can be configured to, e.g., incrementally increase the rate at which milling drum 110 descends into work surface 116 from a default rate while also receiving information from pressure sensor(s) 120 indicative of the pressure of actuators 114 and comparing the pressure to a threshold. When the measured pressure reaches the threshold pressure, controller(s) 118 can set a constant rate (determined maximum) at which milling drum 110 descends into work surface 116.

In an example, the operator inputs or otherwise selects a threshold pressure of actuators 114 based upon for controller(s) 118 to control the plunge velocity of milling drum 110 and commences the milling operation with work machine 102. As work machine 102 mills work surface 116, pressure sensor(s) 120 measure the pressure in one or more of actuators 114 and send information to controller(s) 118 indicative of the pressure of the actuators. Controller(s) 118 control a rate at which milling drum 110 descends into work surface 116 based on the pressure.

For example, pressure sensor(s) 120 are arranged and configured to measure pressure on the head and rod end of one or more of actuators 114. In examples, a first pressure sensor is configured to measure a pressure on the head end of one of actuators 114 and a second pressure sensor 120 is configured to measure a pressure on rod end of the actuator. Controller(s) 118 calculate a measured differential pressure that is equal to the head pressure minus the rod pressure measured by pressure sensor(s) 120. Controller(s) 118 compare the measured differential pressure of actuators 114 to a threshold differential pressure and modulate the plunge velocity of milling drum 110 based on the comparison, including, e.g. reducing the plunge velocity if the differential pressure is less than the threshold or increasing the plunge velocity if the pressure is greater than the threshold.

Controllers in examples according to this disclosure, e.g., controller(s) 118 can include one or more controllers located on or remote from a machine. For example, controllers in accordance with examples of this disclosure can be included in or separate from a machine. Examples according to this disclosure may include multiple controllers working in conjunction with each other to execute functions attributed to the controller(s). In examples, controller(s) can be part of or included in an electronic control unit ECU of a work machine.

Controller(s), ECUs, etc. included in examples according to this disclosure can be configured to communicate with one another and with other components of the work machine via various wired or wireless communications technologies and components using various public and/or proprietary standards and/or protocols. Examples of transport mediums and protocols for electronic communication between components of the work machine include Controller Area Network (CAN) protocol, Ethernet, Transmission Control Protocol/Internet Protocol (TCP/IP), IEEE 802.11 or Bluetooth, or other standard or proprietary transport mediums and communication protocols.

In some examples, controller(s) can be included in an ECU of a machine. An electronic control unit (ECU) can be an embedded system that controls various aspects of machine operation. Types of ECUs include Electronic/Engine Control Module, Powertrain Control Module, Transmission Control Module, Brake Control Module, Suspension Control Module, among other examples. In the case of industrial, construction, and other heavy machinery, example ECUs can also include an Implement Control Module associated with one or more implements connected to and operable from the machine. These electronic modules/units can be communicatively connected and configured to send and receive data, sensor or other digital and/or analog signals, and other information between the various ECUs of the machine. Additionally, functions attributed to a controller, ECU, and the like, can be distributed among multiple devices.

Controller(s), whether onboard and/or separate from a machine, can include software, hardware, and combinations of hardware and software configured to execute a number of functions attributed to the components in the disclosed examples. Such controllers in examples according to this disclosure can be an analog, digital, or combination analog and digital controller including a number of components. As examples, the controller(s) can include integrated circuit boards or ICB(s), printed circuit boards PCB(s), processor(s), data storage devices, switches, relays, etcetera. Examples of processors can include any one or more of a microprocessor, a controller, a digital signal processor (DSP), an application specific integrated circuit (ASIC), a field-programmable gate array (FPGA), or equivalent discrete or integrated logic circuitry.

Controller(s), ECUs and other electronic controls in examples according to this disclosure can include storage media to store and/or retrieve data or other information, for example, signals from sensors. Examples of non-volatile storage devices include magnetic hard discs, optical discs, floppy discs, flash memories, or forms of electrically programmable memories (EPROM) or electrically erasable and programmable (EEPROM) memories. Examples of volatile storage devices include random access memories (RAM), dynamic random access memories (DRAM), static random access memories (SRAM), and other forms of volatile storage devices. The data storage devices can be used to store program instructions for execution by processor(s) of, for example, the controller(s).

Additionally, controller(s), ECUs and other electronic controls in examples according to this disclosure can include additional digital and/or analog components, including transmitters, receivers, transceivers, positioning systems, e.g., Global Positioning Systems, as examples. In an example, controller(s) and/or ECUs can include GPS from which/by which the controller and/or ECU can send and receive data indicative of machine or other element position on a worksite, as well as store and reference 2D or 3D maps of the worksite.

In the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific examples. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific examples. However, the benefits, advantages, solutions to problems, and any feature(s) that may cause any benefit, advantage, or solution to occur or become more pronounced are not to be construed as a critical, required, or essential feature of any or all the claims. Moreover, the particular examples disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular examples disclosed above may be altered or modified and all such variations are considered within the scope of the disclosed subject matter. Accordingly, the protection sought herein is as set forth in the claims below.

What is claimed is:

1. A work machine comprising:
a frame;
a milling drum connected to the frame;
a traction device including an actuator configured to controllably raise and lower the frame relative to a work surface;
a pressure sensor operatively connected to and configured to measure a pressure of the actuator; and
a controller communicatively connected to the pressure sensor and configured to:
receive information from the pressure sensor indicative of the pressure of the actuator; and
control a rate at which the milling drum descends into the work surface based on the pressure.

2. The work machine of claim 1, wherein the controller configured to:
compare the pressure of the actuator to a threshold pressure; and
control the rate at which the milling drum descends into the work surface based on the comparison.

3. The work machine of claim 2, wherein, on condition the controller determines that the pressure of the actuator is less than the threshold pressure, the controller is configured to reduce the rate at which the milling drum descends into the work surface.

4. The work machine of claim 2, wherein, on condition the controller determines that the pressure of the actuator is greater than the threshold pressure, the controller is configured to increase the rate at which the milling drum descends into the work surface.

5. The work machine of claim 1, wherein the controller is configured to:
receive information from the pressure sensor indicative of a plurality of pressures of the actuator at a plurality of times;
determine a change in pressure of the actuator based on the plurality of pressures of the actuator at the plurality of times; and
control the rate at which the milling drum descends into the work surface based on the change in pressure.

6. The work machine of claim 5, wherein the controller configured to:
compare the change in pressure of the actuator to a threshold change in pressure; and
control the rate at which the milling drum descends into the work surface based on the comparison.

7. The work machine of claim 1, wherein the actuator comprises a hydraulic cylinder having a head end and a rod end, wherein the pressure sensor is a first pressure sensor configured to measure a head end pressure and further comprising a second pressure sensor configured to measure a rod end pressure, and wherein the controller is configured to:
receive information from the first pressure sensor and the second pressure sensor indicative of the head end pressure and the rod end pressure;
calculate a pressure differential of the actuator as equal to the head end pressure minus the rod end pressure; and
control the rate at which the milling drum descends into the work surface based on the pressure differential.

8. The work machine of claim 7, wherein, on condition the controller determines that the pressure differential of the actuator is greater than the threshold pressure, the controller is configured to reduce the rate at which the milling drum descends into the work surface.

9. The work machine of claim 1, wherein the controller is configured to:
receive information from the pressure sensor indicative of a plurality of pressures of the actuator at a plurality of times;
determine a rate of change in pressure of the actuator based on the plurality of pressures of the actuator at the plurality of times; and
control the rate at which the milling drum descends into the work surface based on the rate of change in pressure.

10. The work machine of claim 9, wherein the controller configured to:
compare the rate of change in pressure of the actuator to a threshold rate of change in pressure; and
control the rate at which the milling drum descends into the work surface based on the comparison.

11. The work machine of claim 1, wherein the controller configured to:
control the milling drum to descend into the work surface at a default rate;
receive the information from the pressure sensor indicative of the pressure of the actuator; and
change the rate at which the milling drum descends into the work surface based on the pressure.

12. The work machine of claim 1, wherein the default rate at which the milling drum descends into the work surface is based on a depth of cut.

13. The work machine of claim 1, wherein the controller configured to:
vary the rate at which the milling drum descends into the work surface;
receive the information from the pressure sensor indicative of the pressure of the actuator; and
set a constant rate at which the milling drum descends into the work surface based on the pressure.

14. A method comprising:
receiving information from one or more pressure sensors indicative of a pressure of an actuator of a work machine, the work machine including a milling drum connected to a frame and a traction device including the actuator, the actuator configured to controllably raise and lower the frame relative to a work surface; and
controlling a rate at which the milling drum descends into the work surface based on the pressure.

15. The method of claim 14, further comprising:
comparing the pressure of the actuator to a threshold pressure; and
controlling the rate at which the milling drum descends into the work surface based on the comparison.

16. The method of claim 15, wherein, on condition the pressure of the actuator is less than the threshold pressure, reducing the rate at which the milling drum descends into the work surface.

17. The method of claim 14, wherein the actuator comprises a hydraulic cylinder having a head end and a rod end, and further comprising:
receiving information from the one or more pressure sensors indicative of a head end pressure and a rod end pressure;
calculating a pressure differential of the actuator based on the head end pressure minus the rod end pressure; and
controlling the rate at which the milling drum descends into the work surface based on the pressure differential.

18. The method of claim 14, further comprising:
receiving information from the one or more pressure sensors indicative of a plurality of pressures of the actuator at a plurality of times;
determining a rate of change in pressure of the actuator based on the plurality of pressures of the actuator at the plurality of times;
comparing the rate of change in pressure of the actuator to a threshold rate of change in pressure; and
controlling the rate at which the milling drum descends into the work surface based on the comparison.

19. The method of claim 14, further comprising:
controlling the milling drum to descend into the work surface at a default rate; and
changing the rate at which the milling drum descends into the work surface based on the pressure.

20. The method of claim 14, further comprising:
varying the rate at which the milling drum descends into the work surface; and
setting a constant rate at which the milling drum descends into the work surface based on the pressure.
